(19) United States
(12) Patent Application Publication
(10) Pub. No.: US 2025/0124595 A1
(43) Pub. Date: Apr. 17, 2025

(54) PROCESSING DEVICE, PROCESSING SYSTEM, MIXED REALITY DEVICE, PROCESSING METHOD, AND STORAGE MEDIUM

(71) Applicant: KABUSHIKI KAISHA TOSHIBA, Tokyo (JP)

(72) Inventors: Sumire NISHIJIMA, Kodaira Tokyo (JP); Takanori YOSHII, Kawasaki Kanagawa (JP); Kyotaro HAYASHI, Yokohama Kanagawa (JP); Hiroaki NAKAMURA, Kawasaki Kanagawa (JP); Yoshiyuki HIRAHARA, Mishima Shizuoka (JP); Takehiro KATO, Yokohama Kanagawa (JP); Yasuo NAMIOKA, Nerima Tokyo (JP)

(21) Appl. No.: 18/910,513

(22) Filed: Oct. 9, 2024

(30) Foreign Application Priority Data
Oct. 11, 2023 (JP) 2023-176177

(51) Int. Cl. G06T 7/73; G06T 7/33; G06T 19/00

(52) U.S. Cl. CPC G06T 7/73; G06T 7/337; G06T 19/006; G06T 2207/30196; G06T 2207/30204

(57) ABSTRACT

According to one embodiment, a processing device is configured to acquire an image including a hand of a worker and a plurality of markers attached to a first tool for turning a screw. The processing device is further configured to calculate a first position of the first tool based on a plurality of positions of the plurality of markers in a case where the hand touches a virtual first object. The processing device is further configured to determine whether a screw is turned at a fastening location corresponding to the first object based on a first distance between the first object and the first position.

### CROSS-REFERENCE TO RELATED APPLICATIONS

This application is based upon and claims the benefit of priority from Japanese Patent Application No. 2023-176177, filed on Oct. 11, 2023; the entire contents of which are incorporated herein by reference.

### FIELD

Embodiments of the present invention generally relate to a processing device, a processing system, a mixed reality device, a processing method, and a storage medium.

### BACKGROUND

When manufacturing an article, screws may be tightened. Alternatively, screws may be loosened when an article is maintained, inspected, or repaired. There is a need for technology that can better support these tasks involving screws.

### BRIEF DESCRIPTION OF THE DRAWINGS

FIG. 1 is a schematic diagram illustrating a configuration of the processing system according to a first embodiment;

FIG. 2 is a schematic view illustrating a mixed reality device according to an embodiment;

FIG. 3 is a schematic view illustrating an article to be worked on;

FIG. 4 is a schematic view for explaining the first embodiment of the present invention;

FIG. 5 is a schematic view for explaining the first embodiment of the present invention;

FIG. 6 is a schematic view for explaining the first embodiment of the present invention;

FIG. 7 is a schematic view for explaining the first embodiment of the present invention;

FIG. 8 is a schematic view for explaining the first embodiment of the present invention;

FIG. 9 is a schematic view illustrating an appearance of a task;

FIGS. 10A and 10B are schematic views illustrating the appearance of the task;

FIGS. 11A and 11B are schematic views illustrating output examples in the embodiment of the present invention;

FIG. 12 is a flowchart illustrating an example of a processing method according to the embodiment;

FIG. 13A is a schematic view illustrating an example of a tool, and FIGS. 13B to 13D are schematic views illustrating an example of a marker.

FIGS. 14A to 14H are schematic views for explaining processing in the processing system according to the embodiment;

FIG. 15 is a schematic view illustrating a movement of the tool;

FIG. 16 is a system of equations representing a relationship between a position of each marker before movement and a position of each marker after movement;

FIG. 17 is a matrix representing a relationship between a position of the tool before movement and a position of the tool after movement;

FIG. 18 is a flowchart illustrating processes related to calculating the position of the tool;

FIG. 19 is a flowchart illustrating processes related to calculating the position of the tool;

FIG. 20A and FIG. 20B are schematic views for illustrating filters;

FIG. 21A and FIG. 21B are schematic views for illustrating filters;

FIG. 22 is a schematic view for explaining a first modification of the embodiment;

FIG. 23 is a schematic view for explaining the first modification of the embodiment;

FIG. 24 is a schematic view for explaining the first modification of the embodiment;

FIG. 25A is a schematic view illustrating an example of a first tool, and FIG. 25B is a schematic view illustrating an example of a second tool;

FIGS. 26A and 26B are schematic views for explaining a second modification of the embodiment;

FIGS. 27A and 27B are schematic views for explaining a second modification of the embodiment;

FIG. 28 is a flowchart illustrating a processing method according to the second modification of the embodiment;

FIG. 29 is a flowchart illustrating the flow of data in the processing method according to the embodiment; and

FIG. 30 is a schematic diagram illustrating a hardware configuration.

### DETAILED DESCRIPTION

According to one embodiment, a processing device is configured to acquire an image including a hand of a worker and a plurality of markers attached to a first tool for turning a screw. The processing device is further configured to calculate a first position of the first tool based on a plurality of positions of the plurality of markers in a case where the hand touches a virtual first object. The processing device is further configured to determine whether a screw is turned at a fastening location corresponding to the first object based on a first distance between the first object and the first position.

Embodiments of the invention will now be described with reference to the drawings.

The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated.

In the drawings and the specification of the application, components similar to those described thereinabove are marked with like reference numerals, and a detailed description is omitted as appropriate.

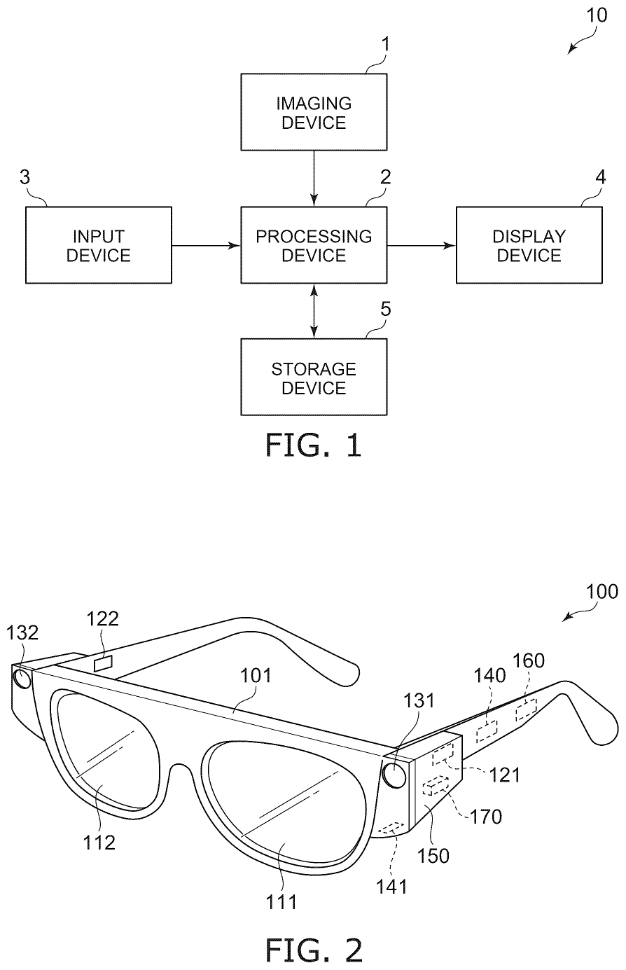

FIG. 1 is a schematic view illustrating a configuration of the processing system according to a first embodiment.

The first embodiment of the present invention is applicable to the task of turning a screw with a tool. As shown in FIG. 1, the processing system 10 includes an imaging device 1, a processing device 2, an input device 3, a display device 4, and a storage device 5.

The imaging device 1 images the state of the task. For example, in the task, fasteners such as screws are tightened to the article using a tool. Alternatively, the screws fastened to the article are loosened using a tool. The article is a part for manufacturing a product, a unit, or a semi-finished product. The Tool may be a wrench, a screwdriver, etc. Here, mainly an example where the embodiment of the present invention is applied to a fastening task of tightening a screw will be described.

When assembling an article, the worker holds a tool in the hand and tightens the screws. The imaging device 1 images the left or right hand of the worker holding the tool. For example, the imaging device 1 includes a camera that acquires RGB images and depth images.

The processing device 2 receives continuous images (movie) captured by the imaging device 1. The processing device 2 recognizes the left hand or right hand in the image. Hand tracking is used for recognition of the left or right hand. Hereinafter, when there is no particular distinction between the left hand and the right hand, at least one of the left hand and the right hand is simply referred to as “the hand”.

The input device 3 is used by the worker to input information to the processing device 2. The input device 3 includes a microphone. The worker can input information to the processing device 2 by speaking to the input device 3. For example, a voice corresponding to a voice command is input to the input device 3. Besides using the input device 3, the worker can input information to the processing device 2 by hand gestures or similar methods.

The display device 4 displays information to the worker. The processing device 2 causes the display device 4 to display information to support the fastening task. Hereinafter, the processing device displays information on the display device, which is simply referred to as “the processing device displays information”. For example, the processing device 2 displays a virtual object indicating the position where the worker's hand should be positioned, hand recognition results, etc. during the fastening task.

The storage device 5 stores data necessary for the processing by the processing device 2, data obtained by the processing of the processing device 2, etc. For example, the storage device 5 stores data on tools used in task, data necessary for calculating the position of tools described later, etc.

The processing device 2 determines whether an inappropriate task is performed from the image acquired by the imaging device 1. Specifically, the processing device 2 determines from the image whether the hand comes in contact with a virtual object. Additionally, the processing device 2 calculates the position of the tool from the image. Multiple markers are attached to the tool, and the processing device 2 calculates the position of the tool from the positions of the multiple markers. The processing device 2 calculates the distance between the position of the tool and the position of the object, and determines whether the task is appropriate based on the distance.

FIG. 2 is a schematic view illustrating a mixed reality device according to an embodiment.

The processing system 10 shown in FIG. 1 is realized, for example, as a mixed reality (MR) device. The MR device 100 shown in FIG. 2 includes a frame 101, a lens 111, a lens 112, a projection device 121, a projection device 122, an image camera 131, a depth camera 132, a sensor 140, a microphone 141, a processing device 150, a battery 160, and a storage device 170.

The image camera 131 and the depth camera 132 are examples of the imaging device 1. The processing device 150 is an example of the processing device 2. The microphone 141 is an example of the input device 3. The projection device 121 and the projection device 122 are examples of the display device 4. The storage device 170 is an example of the storage device 5.

In the illustrated example, the MR device 100 is a binocular-type head-mounted display. Two lenses 111 and 112 are embedded in the frame 101. The projection devices 121 and 122 project information onto lenses 111 and 112, respectively.

The projection device 121 and the projection device 122 display the detection result of the worker's body, a virtual object, etc. on the lens 111 and the lens 112. Only one of the projection device 121 and the projection device 122 may be provided, and information may be displayed on only one of the lens 111 and the lens 112.

The lens 111 and the lens 112 are transparent. The worker can see the real-space environment through the lens 111 and the lens 112. The worker can also see the information projected onto the lens 111 and the lens 112 by the projection device 121 and the projection device 122. The projections by the projection device 121 and the projection device 122 display information overlaid on the real space.

The image camera 131 detects visible light and acquires a two-dimensional image. The depth camera 132 emits infrared light and acquires a depth image based on the reflected infrared light. The sensor 140 is a 6-axis detection sensor, and can detect 3-axis angular velocity and 3-axis acceleration. The microphone 141 accepts voice input.

The processing device 150 controls each element of the MR device 100. For example, the processing device 150 controls the display by the projection device 121 and the projection device 122. The processing device 150 detects the movement of the field of view based on the detection result by the sensor 140. The processing device 150 changes the display by the projection device 121 and the projection device 122 in response to the movement of the field of view. In addition, the processing device 150 can perform various processes using data obtained from the image camera 131 and the depth camera 132, the data of the storage device 170, etc. The battery 160 supplies the power necessary for operation to each element of the MR device 100. The storage device 170 stores data necessary for the processing of the processing device 150, data obtained by the processing of the processing device 150, etc. The storage device 170 may be provided outside the MR device 100 and communicate with the processing device 150.

Not limited to the illustrated example, the MR device according to the embodiment may be a monocular-type head mounted display. The MR device may be a glasses-type as illustrated, or may be a helmet type.

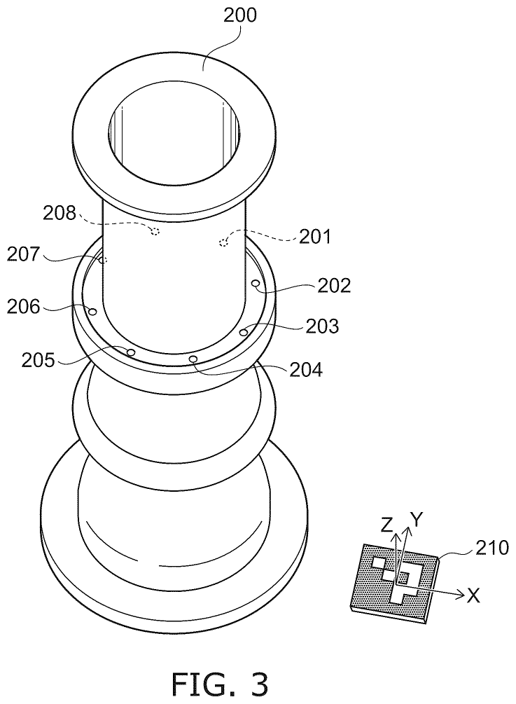

FIG. 3 is a schematic view illustrating an article to be worked on.

For example, a fastening task is performed on the article 200 shown in FIG. 3. The article 200 is a cylindrical hollow member and has fastening locations 201 to 208. The worker uses a wrench to tighten screws at each of the fastening locations 201 to 208.

A marker 210 is provided near the workpiece. In the illustrated example, the marker 210 is an AR marker. As will be described later, the marker 210 is provided for setting an origin of the three-dimensional coordinate system. Instead of the AR marker, a one-dimensional code (barcode), a two-dimensional code (QR code (registered trademark)), or the like may be used as the marker 210. Alternatively, instead of the marker, the origin may be indicated using a hand gesture. The processing device 150 sets a three-dimensional coordinate system based on multiple points indicated by the hand gesture.

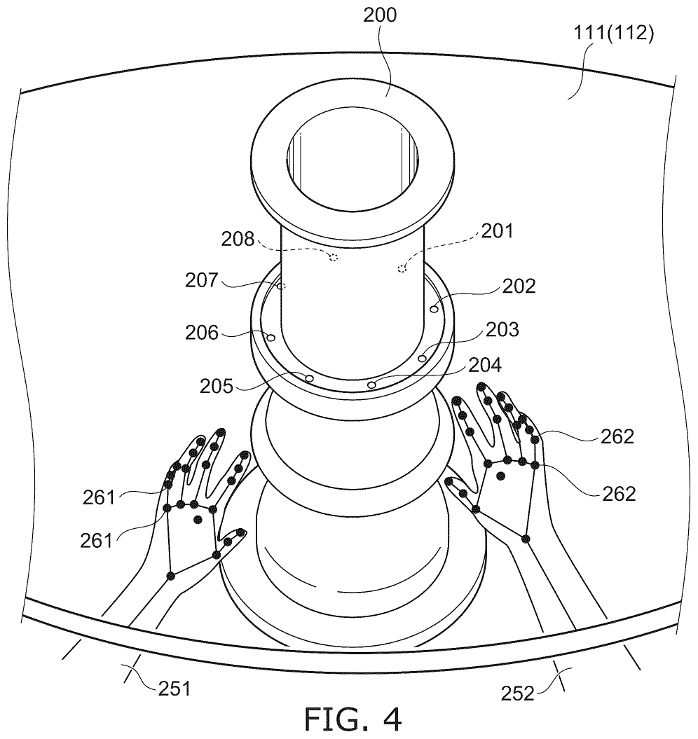

FIGS. 4 to 8 are schematic views for explaining the first embodiment of the present invention.

At the start of the fastening task, the image camera 131 and the depth camera 132 images marker 210. The processing device 150 recognizes the marker 210 from the acquired image. The processing device 150 sets a three-dimensional coordinate system based on the position and orientation of the marker 210.

The image camera 131 and the depth camera 132 image the article 200, the worker's left hand, and the worker's right hand. The processing device 150 recognizes the left hand and the right hand from the acquired image. The processing device 150 measures the position of the recognized hand. The hand includes multiple joints, such as DIP joints, PIP joints, MP joints, CM joints, etc. The position of any of these joints is used as the position of the hand. The position of the center of gravity of the multiple joints may be used as the position of the hand. Alternatively, the overall center position of the hand may be used as the position of the hand. The processing device 150 causes the projection device 121 and the projection device 122 to display the recognition result on the lens 111 and the lens 112. Hereinafter, the processing device causes the projection device to display information on the lens, which is also simply referred to as “the processing device displays information”.

For example, as shown in FIG. 4, the processing device 150 displays the recognition result of the left hand 251 and the recognition result of the right hand 252 superimposed on the hand in real space. In the illustrated example, multiple objects 261 and multiple objects 262 are displayed as recognition results of the left hand 251 and the right hand 252. The multiple objects 261 indicate multiple joints of the left hand 251, respectively. The multiple objects 262 indicate multiple joints of the right hand 252, respectively. Instead of joints, virtual objects respectively indicating the surface shape of the left hand 251 and the surface shape of the right hand 252 may be displayed.

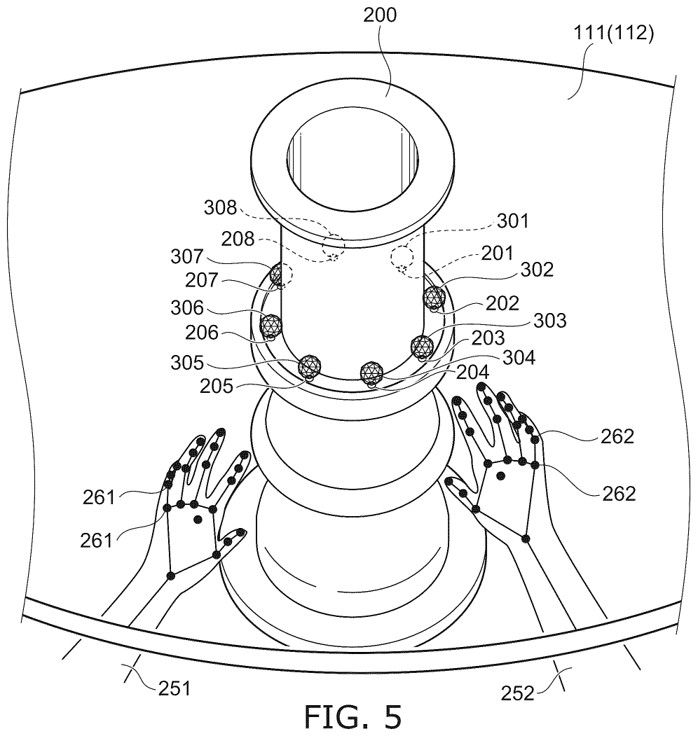

Further, as shown in FIG. 5, the processing device 150 displays virtual objects 301 to 308 (examples of first objects) corresponding to the fastening locations 201 to 208. The objects 301 to 308 indicates positions where the worker's hand should be located when the fastening locations 201 to 208 are fastened, respectively. In the illustrated example, the objects 301 to 308 are spheres. As long as the worker can see it separately from the real space, the shape, color, etc. of each object are arbitrary.

The positions at which the objects 301 to 308 are displayed are registered in advance using the coordinate system based on the origin of the marker 210. The three-dimensional coordinate system used for registering the display positions of the objects 301 to 308 and the three-dimensional coordinate system set during the task are common. The positional relationship between the article 200 and the marker 210 when preparing the object is adjusted in the same way as the positional relationship between the article 200 and the marker 210 when the task is performed. Thereby, the prepared object can be displayed superimposed on the article 200 at an appropriate position during the task.

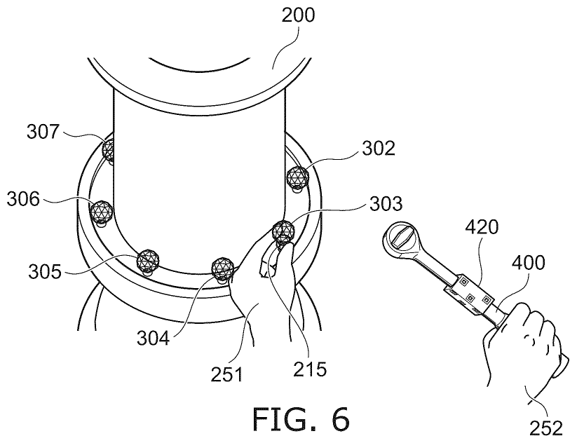

As an example, the worker tightens a screw to the fastening location 203. In such a case, the worker places the screw 215 in the screw hole of the fastening location 203 as shown in FIG. 6. Next, the worker holds the grip of the wrench 400 with his right hand. The wrench 400 is an example of a first tool. A socket is attached to the tip (head) of the wrench 400. The worker fits the tip to the screw 215. Thereafter, the worker rotates the wrench 400 with the right hand 252 while holding the head of the wrench 400 with the left hand 251. Thereby, the screw 215 is tightened.

In the series of actions described above, the processing device 150 determines whether the left hand 251 or right hand 252 comes into contact with any virtual object. More specifically, the processing device 150 calculates the distance between the position of the hand and the object. When the distance is less than a preset threshold, the processing device 150 determines that the hand comes into contact with the object. As an example, in FIG. 5, the diameter of each of the objects 301 to 308 corresponds to a threshold value. The sphere indicates the extent to which it is determined that the hand has come into contact with the virtual object. In the above working example, when fastening the screw, the left hand 251 holding the tip of the wrench has come into contact with the object 303. When the contact between the left hand 251 and the object 303 is determined, the processing device 150 calculates the position of the wrench 400.

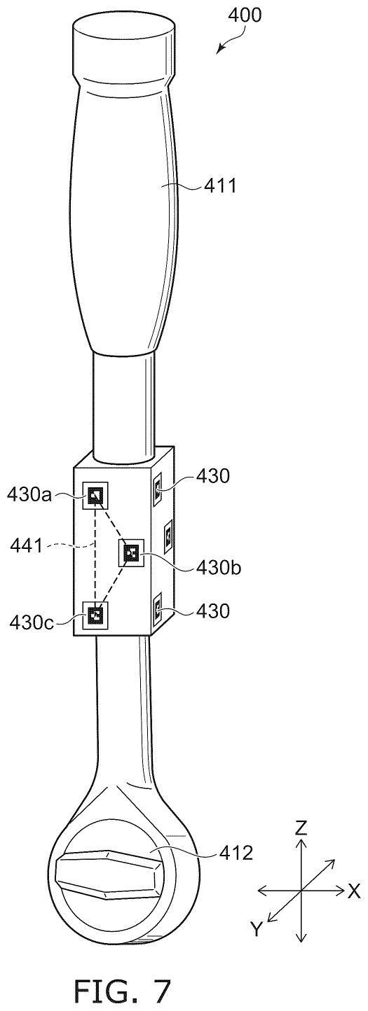

As shown in FIG. 7, multiple markers 430 are attached to the wrench 400. In the illustrated example, a jig 420 is attached to the wrench 400, and multiple markers 430 are attached to the jig 420. The jig 420 has multiple planes. For each plane, three markers 430 are attached.

For three markers 430 on one plane, the distance between one marker 430 and another marker 430 is different from the distance between the one marker 430 and yet another marker 430. That is, three markers 430 are attached so that, when an imaginary triangle connecting the three markers 430 is generated, the triangle does not become an equilateral triangle.

Preferably, multiple markers 430 are arranged so that one side of the triangle is parallel to the direction in which the tool is extended. In the example shown in FIG. 7, the wrench 400 extends in a Z-direction (a first direction). The Z-direction corresponds to the direction connecting the grip 411 of the wrench 400 and the head 412 of the wrench 400. The direction from the marker 430a to the marker 430c is parallel to the Z-direction. The imaginary triangle 441 based on the markers 430a to 430c has the side parallel to the Z-direction.

The processing device 150 detects multiple markers 430 from the images captured by the image camera 131 and the depth camera 132. The processing device 150 calculates the position of the wrench 400 from the positions of at least three markers 430. The position of the part of the wrench 400 that overlaps or is close to the object during an appropriate fastening task is used as the position of the wrench 400. For example, the processing device 150 calculates the position of the head 412 from the positions of at least three markers 430.

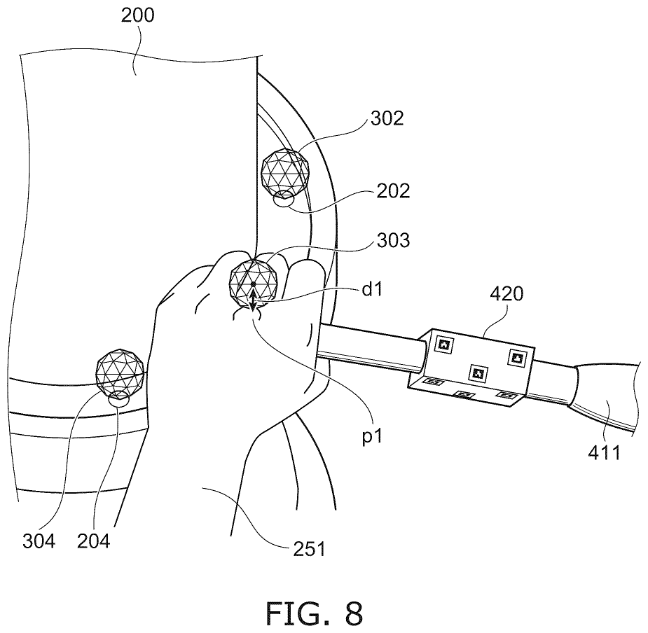

As shown in FIG. 8, the worker holds the head 412 with the left hand 251 and grasps the grip 411 with the right hand, which is not shown. At this time, the left hand 251 comes into contact with the object 303. When the hand comes into contact with the object, it can be presumed that the screw is turned to the fastening location corresponding to the object. Here, the fastening location corresponding to the object in contact with the hand and where it is presumed that a screw is turned is called the “presumed location”.

When the hand comes into contact with the object, the processing device 150 calculates the first position p1 of the head 412 from the positions of the multiple markers 430. The first position p1 is represented by the coordinates of a three-dimensional coordinate system set using the marker 210. The processing device 150 calculates the first distance d1 between the first position p1 and the object 303 in contact with the hand.

The processing device 150 compares the first distance d1 with a preset first threshold. When the first distance d1 is greater than the first threshold, the processing device 150 determines that the screw has not been turned to the presumed location. When the first distance d1 is less than or equal to the first threshold, the processing device 150 determines that the screw is turned to the presumed location.

When the screw is determined to be turned at the presumed location, the processing device 150 generates a task record. For example, the processing device 150 associates and stores data indicating that the screw has been tightened to the data related to the fastening location 203.

When a digital tool is used for the fastening task, the processing device 150 may receive detection values from the digital tool. The digital tool includes a sensor that detects the signal generated in the fastening task. When it is determined that a screw is tightened into the presumed location, the processing device 150 associates the detection value with the ID of the fastening location 203 and stores them in the storage device 170. Thereby, a task record can be automatically generated for each fastening location.

When a digital torque wrench or a digital torque screwdriver is used as the tool, the detection value is torque. Alternatively, a threshold value may be set in advance for the torque. The digital torque wrench or digital torque screwdriver may determine whether or not a torque exceeding the threshold value has been detected, and output the determination result as the detection value. The digital tool may further detect the rotation angle and the like.

The advantages of the embodiment will be described.

In order to support the task, the method according to the following reference example can be considered. In the method according to the reference example, a virtual object corresponding to the fastening location is displayed. The object is displayed in the position where the hand should be positioned when the worker performs the task. By displaying the object, it becomes easy for the worker to visually confirm where to place the hand and which fastening location to turn the screw. Additionally, in this method, it is also possible to automatically generate a task record by associating data indicating that the task has been performed with the data of the presumed location.

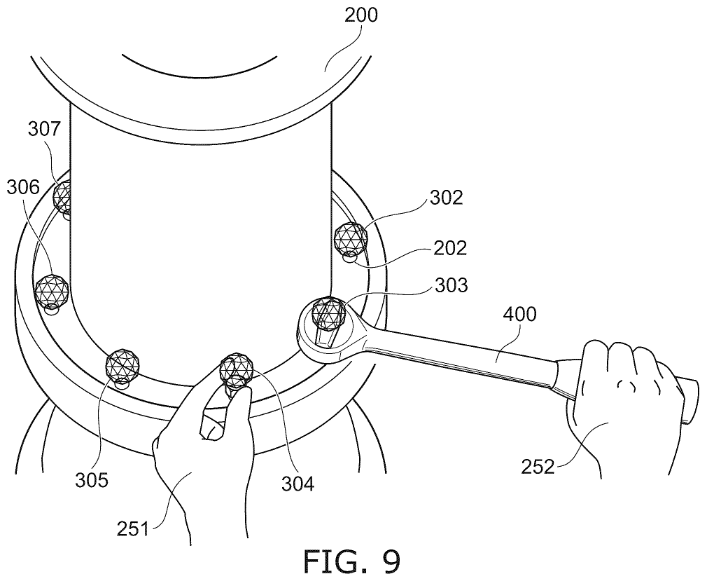

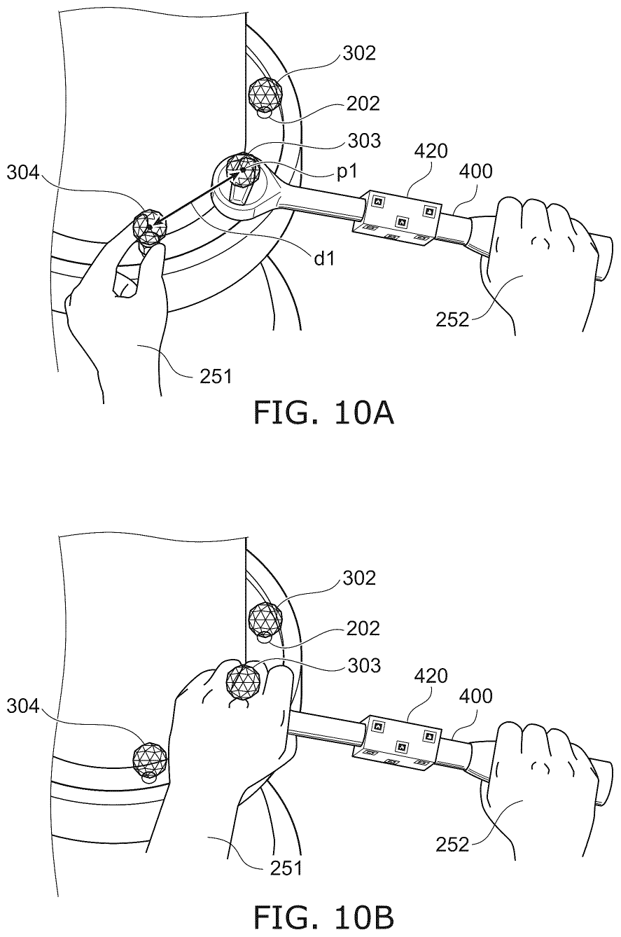

FIG. 9, FIG. 10A, and FIG. 10B are schematic views illustrating the appearance of the task.

In the example shown in FIG. 9, the left hand 251 is in contact with the object 304 corresponding to the fastening location 204. The right hand 252 tightens a screw into the fastening location 203 using the wrench 400. In such a case, since the hand is in contact with the object 304, it is determined that the screw is tightened into the fastening location 204 corresponding to the object 304. By the method according to the reference example, a fastening record for the fastening location 204 is generated even though the screw is actually tightened into the fastening location 203. Therefore, there is a need for technology that can more accurately determine the location where the screw is tightened, regarding the method of the reference example.

In one embodiment of the present invention, the first distance between the object with which the hand comes into contact and the position of the tool is calculated. When the screw is actually turned to the presumed location, the tool is positioned near the presumed location. Therefore, the calculated first distance is also shortened. In the example shown in FIG. 10A, the fastening location at which the screw is tightened by the tool and the fastening location where the hand is positioned are different. In the example shown in FIG. 10B, the screw is tightened into the fastening location where the hand is positioned. In the example shown in FIG. 10B, the first distance d1 is shorter than the one in the example shown in FIG. 10A.

When the first distance d1 is greater than the first threshold, the processing device 2 determines that the screw is not actually turned to the presumed location. When the first distance d1 is less than or equal to the first threshold, the processing device 2 determines that a screw is turned to the presumed location. According to the embodiment, it can be more accurately determined whether or not the screw is actually turned at the fastening location corresponding to the object in contact with the hand. As a result, it is possible to generate a task record more accurately. According to the embodiment, task involving screws can be better supported.

Further, when turning the screw with the tool, it is recommended to rotate the tool while holding the grip and head of the tool with the hands. It is possible to handle the tool by holding only the grip, but there is a possibility of damaging the article or screw due to unintentional movement of the tool during the task. According to the embodiment, it is easier to prevent performing inappropriate tasks as shown in FIG. 10A.

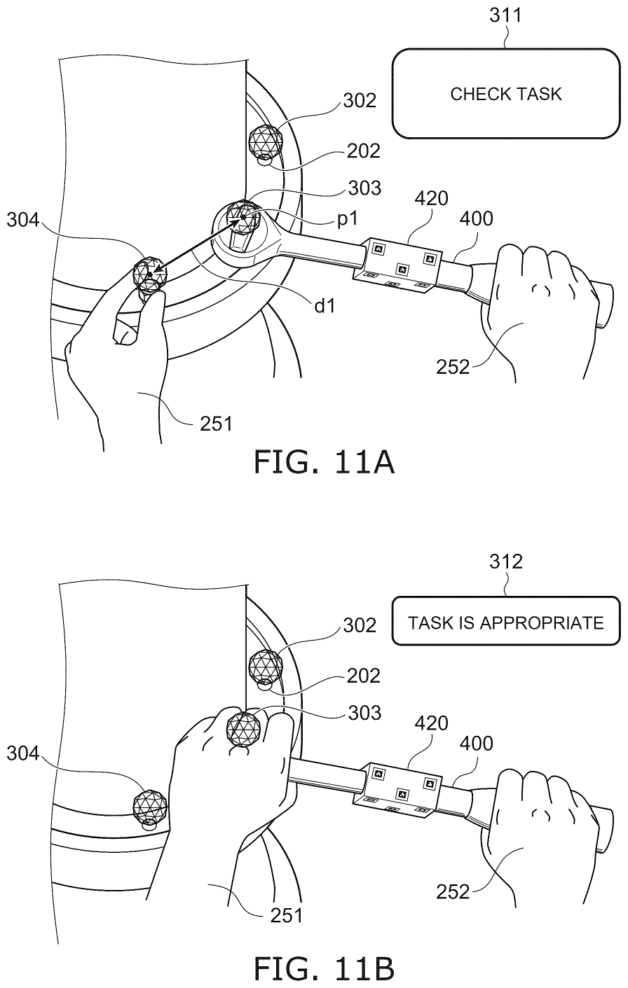

FIGS. 11A and 11B are schematic views illustrating output examples in the embodiment of the present invention.

When the first distance d1 is greater than the first threshold, as shown in FIG. 11A, the processing device 2 may display a message 311 (an alert) encouraging confirmation of the task. The content of the message may be an error code or the like. The display of the message makes it easier for the worker to recognize that an inappropriate task is being performed.

When the first distance d1 is less than or equal to the first threshold, as shown in FIG. 11B, the processing device 2 may display a message 312 indicating that the task is appropriate. Alternatively, the processing device 2 does not display any message.

The first threshold to be compared with the first distance d1 is set in advance by the administrator of the processing system 10. Alternatively, the first threshold value may be automatically calculated by the processing device 2 from the distance between the fastening locations or the length of the tool.

When the fastening of the screw is completed, the worker inputs completion information indicating the completion of the fastening using the input device 3. When it is determined that the screw is tightened into the presumed location, the processing device 2 accepts the input. The processing device 2 associates the completion information with the data related to the presumed location and stores them in the storage device 5.

When a digital tool is used, the processing device 2 receives the detection value from the digital tool. When it is determined that a screw is tightened into the presumed location, the processing device 2 associates the detection value with the data related to the presumed location and stores them in the storage device 5. Thereby, it becomes possible to automatically generate an accurate task record.

At the fastening location where the screw is tightened and the completion information or detection value is received, the processing device 2 hides the object corresponding to the fastening location. Alternatively, the processing device 2 may make the display of the object corresponding to the fastening location different from the display of other objects. Thereby, the worker can easily see the location where the screw has not yet been tightened.

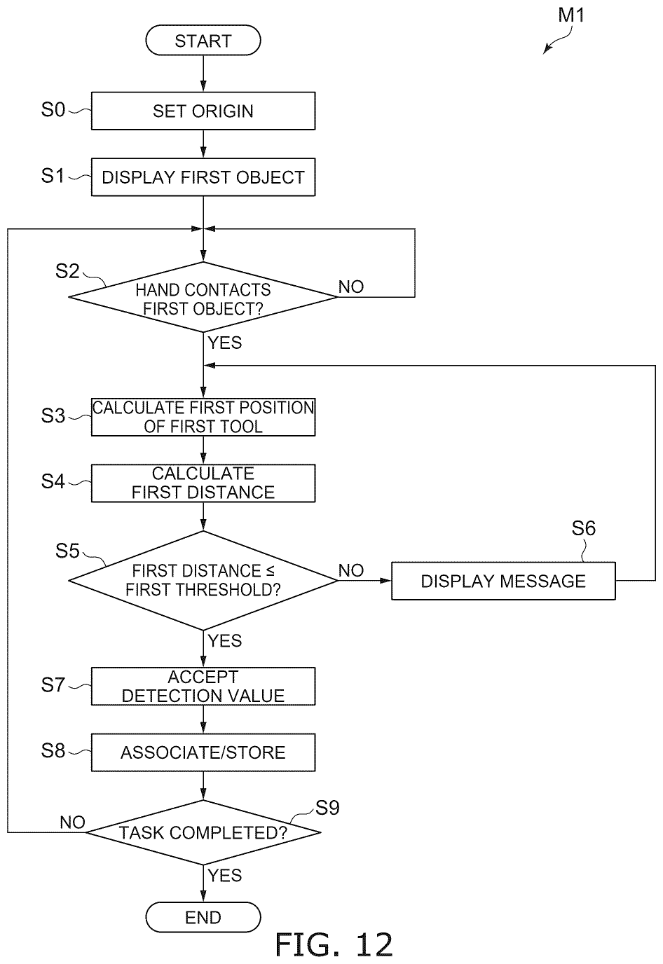

FIG. 12 is a flowchart illustrating an example of a processing method according to the embodiment.

In the processing method M1 shown in FIG. 12, the processing device 2 sets an origin (step S0). The origin is set based on a marker or a hand gesture. The processing device 2 displays one or more first objects corresponding to one or more fastening locations, respectively (step S1). The processing device 2 determines whether the hand comes into contact with any of the first objects (step S2).

When the hand comes into contact with any of the first objects, the processing device 2 calculates the first position of the first tool from multiple markers attached to the first tool (step S3). The processing device 2 calculates the first distance between the first position and the first object with which the hand comes into contact (step S4). The processing device 2 determines whether the first distance is less than or equal to the first threshold value (step S5). When the first distance is greater than the first threshold, the processing device 2 displays a message encouraging the worker to confirm (step S6). Thereafter, the first position is calculated again (step S3).

When the first distance is less than or equal to the first threshold, the processing device 2 accepts the detection value transmitted from the digital tool (step S7). The processing device 2 associates the detection value with the data related to the fastening location and stores them in the storage device 5 (step S8). The processing device 2 determines whether the task is completed (step S9). That is, the processing device 2 determines whether the screw has been turned for all fastening locations at which the objects are displayed. When the task is not completed, the determination in the step S2 is executed again. When it is determined that the task is completed, the processing device 2 terminates the processing method M1 shown in FIG. 12.

Hereinafter, an example of a specific process in the embodiment according to the present invention will be described.

### Registration of Tools and Markers

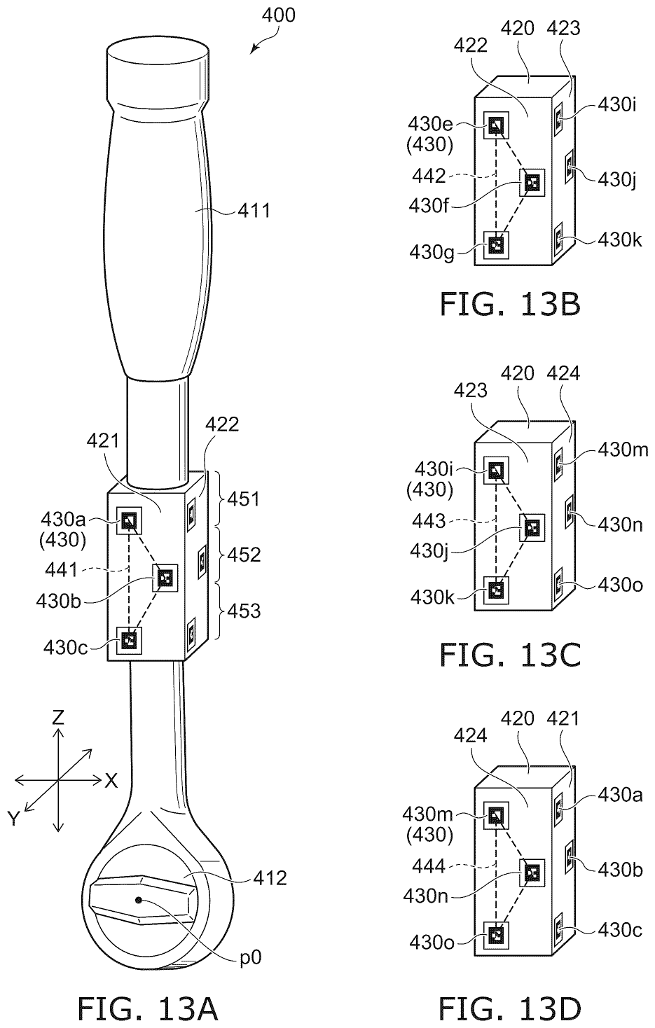

FIG. 13A is a schematic view illustrating an example of the tool. FIGS. 13B to 13D are schematic views illustrating an example of the marker.

The ID of the marker 430, the position of the marker 430, the position of the tool calculated by the marker 430, etc. are registered in advance before the task. FIGS. 13A to 13D show the states when the jig 420 is viewed from different directions. The outer shape of the jig 420 is a rectangular parallelepiped, and the jig 420 has four planes 421 to 424. The plane 421 is affixed with markers 430a to 430c. The plane 422 is affixed with markers 430e to 430g. The plane 423 is affixed with markers 430i to 430k. The plane 424 is affixed with markers 430m to 430ₒ.

The markers 430a to 430c are attached so that the imaginary triangle 441 obtained by connecting these markers becomes an isosceles triangle. Similarly, the markers 430e to 430g, the markers 430i to 430k, and the markers 430m to 430ₒ are attached so that the imaginary triangles 442 to 444 obtained by connecting multiple markers are isosceles triangles, respectively. Each isosceles triangle has a side parallel to the Z-direction. Further, each marker is positioned so that the triangles 441 to 444 are rotationally symmetrical with respect to the center of the X-Y plane of the wrench 400. The X-Y plane is a surface perpendicular to the Z-direction in which the wrench 400 extends.

In the preliminary preparation, the ID of each marker 430 and the position of each marker 430 in an arbitrary spatial coordinate system are registered. In addition, for each combination of markers 430a to 430c, markers 430e to 430g, markers 430i to 430k, and markers 430m to 430ₒ, specific positions of the wrench 400 are registered. A different position may be registered for each combination of markers, or a common position may be registered for each combination. As an example, for each combination of markers, the position p0 shown in FIG. 13A is registered. The registered position is the position where the worker holds the hand when the tool is used in the task.

In addition, for each marker 430, attributes related to the position are registered. The attributes indicate which of the regions 451 to 453 shown in FIG. 13A the markers 430 reside in. The regions 451 to 453 are arranged in the Z-direction. This attribute is used to increase the accuracy of estimating the position of the tool during the task, as described below.

The ID of the marker 430, the position of the marker 430, the position of the tool corresponding to the marker, and the position attributes are stored in association with the ID of the tool. Thereby, the preliminary preparations for the marker are completed. Thereafter, the position of the marker and the position of the tool registered in the preliminary preparation are referred to as “the position of the preliminary marker” and “the position of the preliminary tool”, respectively.

### Calculation of Tool Position

The processing device 2 detects the marker 430 appearing in the image. When four or more markers 430 are recognized, the processing device 2 extracts three markers 430. The processing device 2 calculates the position of the tool from the positions of the three extracted markers 430.

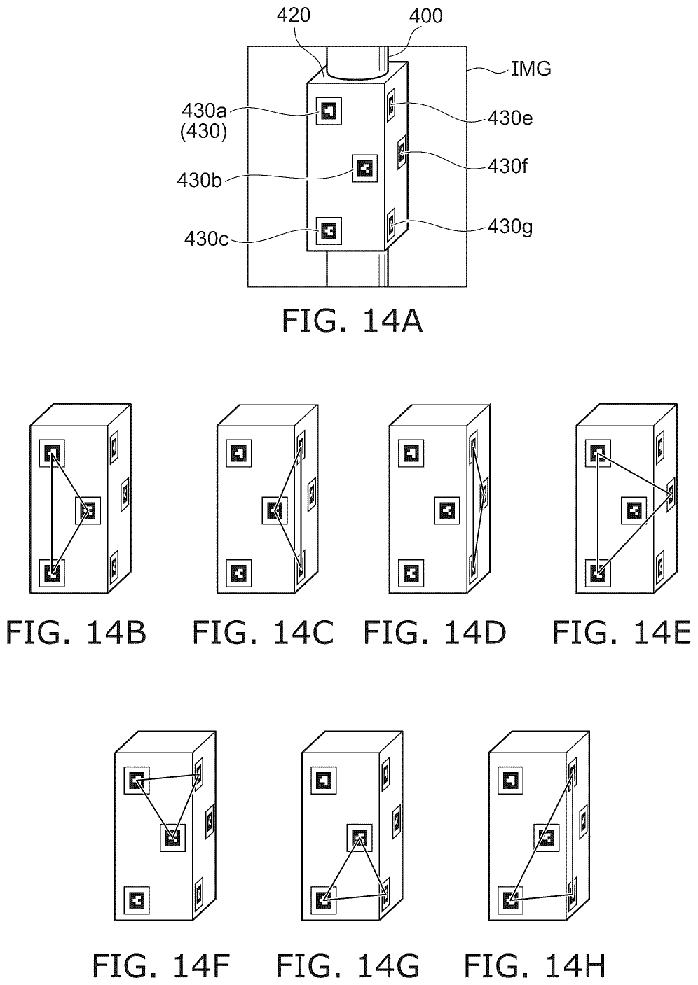

FIGS. 14A to 14H are schematic views for explaining processing in the processing system according to the embodiment. For example, the imaging device 1 acquires the image IMG shown in FIG. 14A. The image IMG includes markers 430a to 430c and markers 430e to 430g. The processing device 2 extracts combinations of three markers 430 from the markers 430a to 430_{c} and the markers 430e to 430g. For each combination, the processing device 2 generates a triangle connecting the three markers 430. FIGS. 14B to 14H show examples of generated triangles.

Next, the processing device 2 refers to the data of each recognized marker 430. As described above, the attribute of the position is registered for each marker 430. The processing device 2 extracts a triangle in which the marker 430 exists in each of the regions 451 to 453 from the generated plurality of triangles. That is, the processing device 2 extracts a triangle having the side along the Z-direction. As a result of the processing, the triangles shown in FIGS. 14B to FIG. 14E are extracted, and the triangles shown in FIGS. 14F to FIG. 14H are not extracted.

The processing device 2 calculates a first vector parallel to the normal of the extracted triangle. In addition, the processing device 2 calculates a second vector connecting the observation point (the imaging device 1) and the center point of the triangle. The processing device 2 calculates the angle between the first vector and the second vector. For each of the extracted triangles, the processing device 2 calculates the angle between the first vector and the second vector.

The processing device 2 extracts one triangle with the smallest angle from the extracted triangles. The processing device 2 determines the marker 430 corresponding to the extracted one triangle as the marker 430 used for calculating the position of the tool. In the illustrated example, the markers 430a to 430c are determined as the markers used to calculate the position of the tool. Hereinafter, the three determined markers are also referred to as “a first marker”, “a second marker”, and “a third marker”.

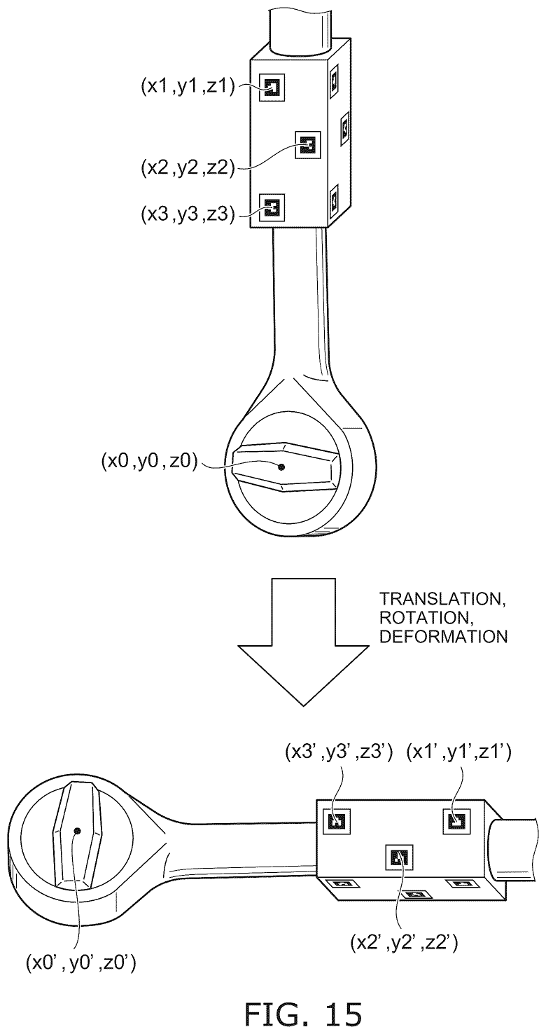

The processing device 2 measures the position of each of the first to third markers. In addition, the processing device 2 refers to the ID of each of the first to third markers. The processing device 2 acquires the positions of the preliminary first to third markers and the position of the preliminary tool corresponding to the first to third marker. The processing device 2 calculates the position of the tool during the task using each position of the first to third markers obtained during the task, each position of the preliminary first to third markers, and the position of the preliminary tool. FIG. 15 is a schematic view illustrating the movement of the tool.

Even When the tool is used in the task, the position of the tool relative to the position of the first to third markers does not change. Here, as shown in FIG. 15, the position of the preliminary first marker is taken as (x1, y1, z1). The position of the preliminary second marker is taken as (x2, y2, z2). The position of the preliminary third marker is taken as (x3, y3, z3). The position of the preliminary tool is taken as (x0, y0, z0). Further, the positions of the first to third markers measured during the task are taken as (x1′, y1′, z1′), (x2′, y2′, z2′), and (x3′, y3′, z3′), respectively. The position of the tool during the task is taken as (x0′, y0′, z0′).

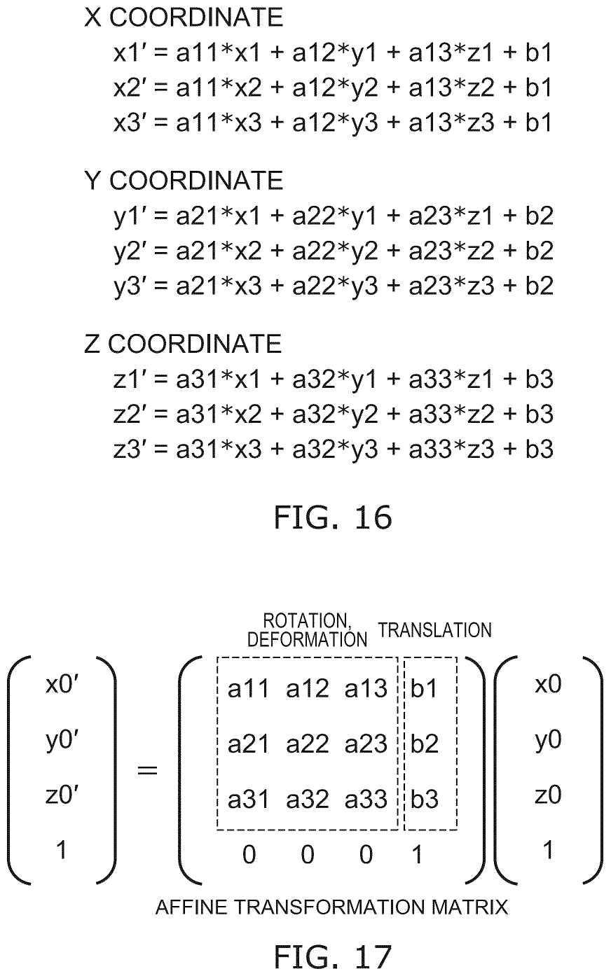

FIG. 16 is a system of equations representing the relationship between the position of each marker before movement and the position of each marker after movement.

The relationship between the position of the preliminary first to third markers and the position of the first to third markers during the task is represented by the equations of FIG. 16. Each position is substituted into the relational equation shown in FIG. 16 to solve the system of equations. At this time, the coefficients b1 to b3 are set to be zero. The coefficients b1 to b3 correspond to the amount of translation from the positions of the preliminary first to third markers to the positions of the first to third markers during the task. By solving the system of equations, the coefficients a11 to a33 can be obtained. The coefficients a11 to a33 indicate the amount of rotation and the amount of deformation from the positions of the preliminary first to third markers to the positions of the first to third markers during the task.

Thereafter, the difference between the position of the midpoint of the preliminary first to third markers the position of the midpoint of the first to third markers during the task is calculated. The difference in the X-direction, the difference in the Y-direction, and the difference in the Z-direction are used as the coefficients b1 to b3, respectively. Note that the spatial coordinate system for registering the position in advance may be different from the spatial coordinate system during the task. In such a case, the change in the origin of the spatial coordinate system is also represented as the rotation, deformation, and translation of each marker.

FIG. 17 is a matrix representing the relationship between the position of the tool before movement and the position of the tool after movement.

The processing device 2 uses the coefficients a11 to a33 and the coefficients b1 to b3 as variables of the affine transformation matrix. As shown in FIG. 17, the position of the tool during the task (x0′, y0′, z0′) is calculated by multiplying the preliminary tool position (x0, y0, z0) by the affine transformation matrix.

The rotation and translation may be calculated by a method other than the affine transformation matrix. For example, the processing device 2 calculates the difference between the center point of the preliminary first to third markers and the center point of the first to third markers during the task as a translational distance. Additionally, the processing device 2 calculates the normal vector of the preliminary first to third markers. Here, the normal vector is referred to as a preliminary normal vector. The processing device 2 calculates the normal vector of the first to third markers during the task. Here, the normal vector during the task is referred to as the current normal vector. The processing device 2 calculates the direction of rotation and the angle of rotation to match the preliminary vector with the current vector. By these processing described above, the translation and rotation of the first to third markers are calculated. The processing device 2 calculates the position of the tool during the task by adding the calculated translation and rotation to the position of the preliminary tool.

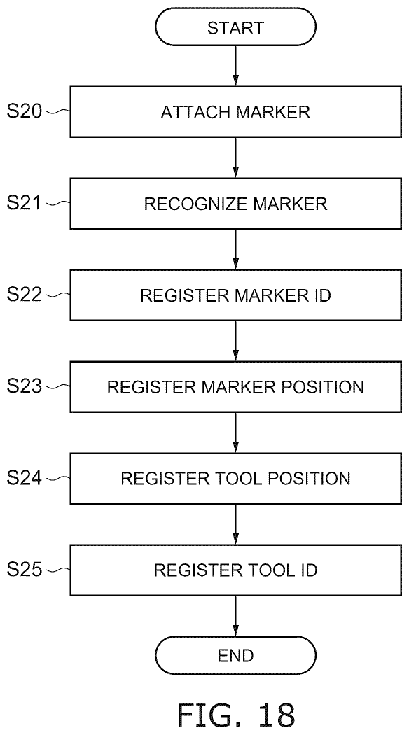

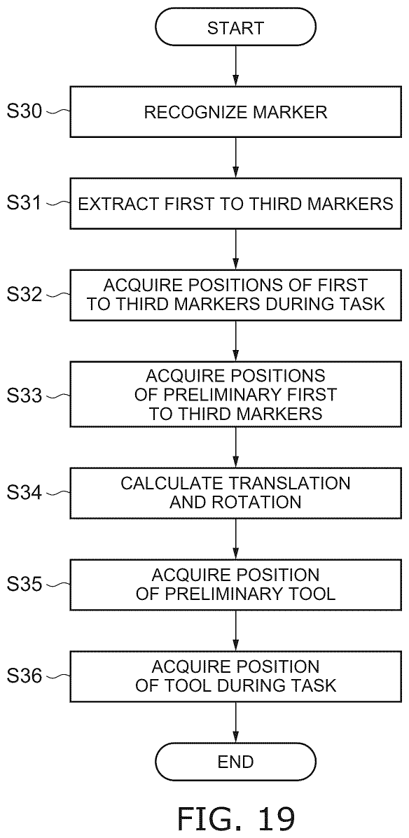

FIGS. 18 and 19 are flowcharts illustrating processes related to calculating the position of the tool.

First, as a preliminary preparation, the processing shown in FIG. 18 is performed. Specifically, the worker attaches multiple markers 430 to the tool (step S20). The worker who attaches the marker 430 may be different from the worker who performs the fastening task. Other than the worker, the marker 430 may be attached by the administrator of the processing system 10, the manager of the tool, etc.

The imaging device 1 images each marker 430, and the processing device 2 recognizes each marker 430 from the image (step S21). The worker registers the ID of each marker (step S22). The processing device 2 calculates the position of each marker and registers it in association with the ID of the marker (step S23). The worker specifies the position of the tool with respect to the combination of markers. The processing device 2 calculates the specified position and registers the position of the tool (step S24). The worker registers the ID of the tool by associating it with the IDs of the markers, the positions of the markers, and the position of the tool (step S25).

Next, during the task, the processing shown in FIG. 19 is executed. Specifically, the processing device 2 recognizes the marker 430 from the image (step S30). The processing device 2 extracts the first to third markers used for calculating the position of the tool from the three or more markers 430 (step S31). The processing device 2 acquires the positions of the first to third markers during the task (step S32). The processing device 2 acquires the positions of the preliminary first to third markers (step S33). The processing device 2 calculates the translation and rotation of the tool (step S34). In addition to the translation and rotation, deformation may be further calculated.

The processing device 2 acquires the preliminary tool position corresponding to the first to third markers (step S35). The processing device 2 calculates the position of the tool during the task using the calculated translation and rotation and the acquired preliminary tool position (step S36). Using the calculated tool position, the processing from the step S4 shown in FIG. 12 is executed.

### Filter

In the above-described example, when generating a triangle, the vertices of the triangle are set at the positions of the markers 430. Alternatively, a triangle may be generated based on three points whose relative positional relationships are fixed. Here, a point whose positional relationship is fixed is called a “fixed point”. In addition, the triangle generated based on three fixed points is called a “filter”. By using a filter, errors in rotation, deformation, and translation of the triangle due to errors in the position of the marker 430 can be reduced.

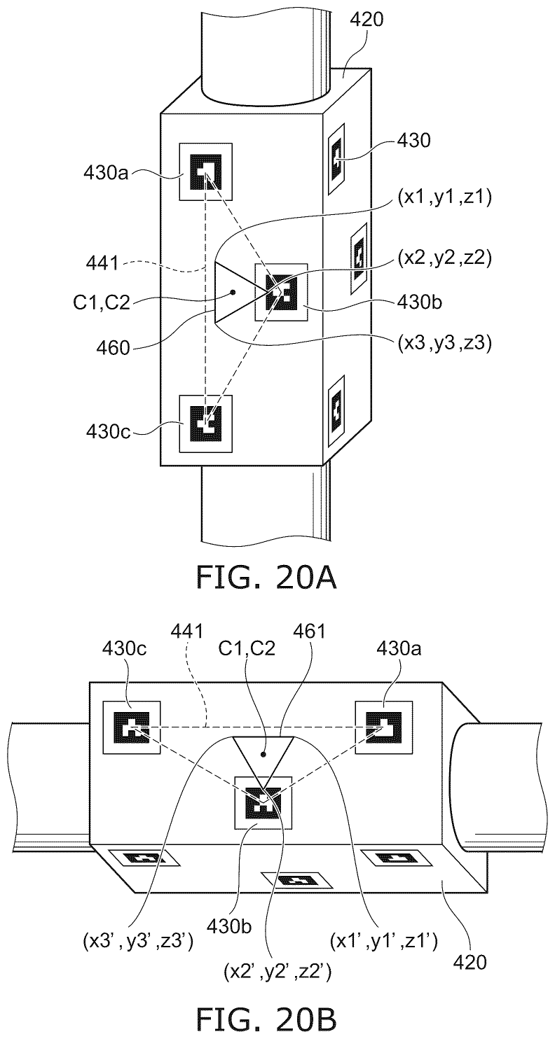

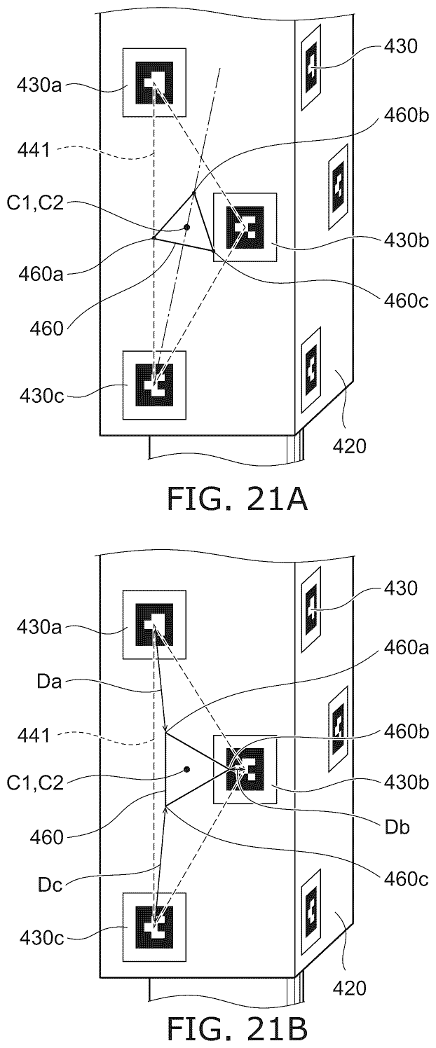

FIG. 20A, FIG. 20B, FIG. 21A, and FIG. 21B are schematic views for illustrating filters.

The processing device 2 sets three fixed points for the combination of the three markers 430 according to a predetermined procedure. The processing device 2 connects three fixed points and generates a filter. For example, as shown in FIG. 20A, the processing device 2 sets the filter 460 to the positions of the preliminary first to third markers. As shown in FIG. 20B, the processing device 2 sets the filter 461 to the positions of the first to third markers during the task. The shape and size of the filter 460 are the same as the shape and size of the filter 461.

In the illustrated example, the center point C2 of the filter is located at the center point C1 at the positions of the three markers 430. Additionally, the direction of the filter is set so that the angle between the normal vector of the triangle 441 based on the three markers 430 and the normal vector of the filter is minimized. An angle around the normal vector is set using one or more markers 430, the center points C1 and C2, and one or more vertices of the filter. One of the following methods is used to set the angle around the normal vector.

As shown in FIG. 21A, the filter 460 has vertices 460a to 460c. The vertices 460a to 460c are individually identifiable. In the first method, the angle of the filter 460 around the normal vector is adjusted so that any one marker 430, the center point C1, the center point C2, and any of the vertices 460a to 460c are aligned in a straight line. More preferably, the filter 460 is rotated so that the marker 430 farthest from the center point C1 or C2 is located in a straight line. By using the marker 430 farthest from the center point, the error can be reduced. By the same method, the angle around the normal vector of the filter 461 is also set. In the second method, as shown in FIG. 21B, the angle of the filter 460 may be adjusted so that the sum of the distance Da between the marker 430a and the vertex 460a, the distance Db between the marker 430b and the vertex 460b, and the distance Dc between the marker 430c and the vertex 460c is minimized. In the examples shown in FIGS. 20A and 20B, the angle of the filter 460 and the angle of the filter 461 are set by the second method.

The processing device 2 uses the positions of the three fixed points of the filter 460 as the positions of the preliminary first to third markers. The processing device 2 uses the positions of the three fixed points of the filter 461 as the positions of the first to third markers during the task. Thereafter, the rotation, deformation, and translation of the tool are calculated by the same method as in the example described above, and the position of the tool during the task is calculated.

When calculating the position of the marker 430 from the image, there is an error in the position. In particular, when measuring the position of the marker 430 from the RGB image, the error of the position of the marker 430 tends to increase due to insufficient resolution, image distortion due to the shooting direction, image distortion due to lens distortion, etc. Regarding the resolution problem, it is preferable to use a high-resolution camera, but the higher the number of pixels in the image, the longer the time required for overall image processing. During the task, it may be difficult to determine whether the screw is fastened in real time. On the other hand, if the resolution is reduced, the image processing can be speeded up, but the error in the position of the marker 430 increases. Additionally, at the time of task, it is rare that the marker 430 is directly facing the imaging device 1. When the marker 430 is positioned obliquely relative to the imaging device 1, the marker 430 in the image is deformed; and the error in the position of the marker 430 increases. Furthermore, the worker's MR device may be positioned close to the tool during the task. When the angle of view of the imaging device 1 is small, the tool may deviate from the angle of view depending on the orientation of the imaging device 1. If the tool and the marker 430 are not in the image, determination using the marker 430 cannot be performed. Therefore, the imaging device 1 preferably includes a wide-angle lens, and the angle of view of the imaging device 1 is large. On the other hand, when the angle of view is large, the distortion increases, especially in the peripheral regions of the image. If the marker 430 is located in the periphery regions of the image and is distorted, the error in the position of the marker 430 increases.

When the error in the position of the marker 430 is large, the errors of rotation, deformation, and translation of the tool calculated from the position also increases. As a result, there is a possibility that an incorrect determination result may be output as to whether or not a screw is tightened into the presumed location. By using the filter, even when the error in the position of the marker 430 is large, the deformation of the generated triangle can be particularly reduced. As a result, it is possible to determine more accurately whether or not a screw is tightened into the presumed location.

### First Modification

In the flowchart shown in FIG. 12, after it is determined that the hand comes into contact with the object, the processing after the step S3 is executed. The subsequent processing in the step S3 is executed only while the hand is in contact with the object. Alternatively, when it is determined that the hand is in contact with the object in the step S2, the steps S3 and subsequent steps may be executed only during a first period. When the hand does not come into contact with the object during the first period, the process is interrupted and returns to the step S2.

The first period can be appropriately set and adjusted. Normally, during the fastening task, the hands are always located at certain positions. In the example shown in FIGS. 5 to 7, the hand grasps the head 412 of the wrench 400, and the position of the hand does not change substantially. Therefore, the first period may be set short.

On the other hand, when working in an unconventional posture or working at a height, it may be difficult to place the hand in a specific position. In such a case, the object may be displayed at the position where the hand passes during the task, and the first period may be set longer.

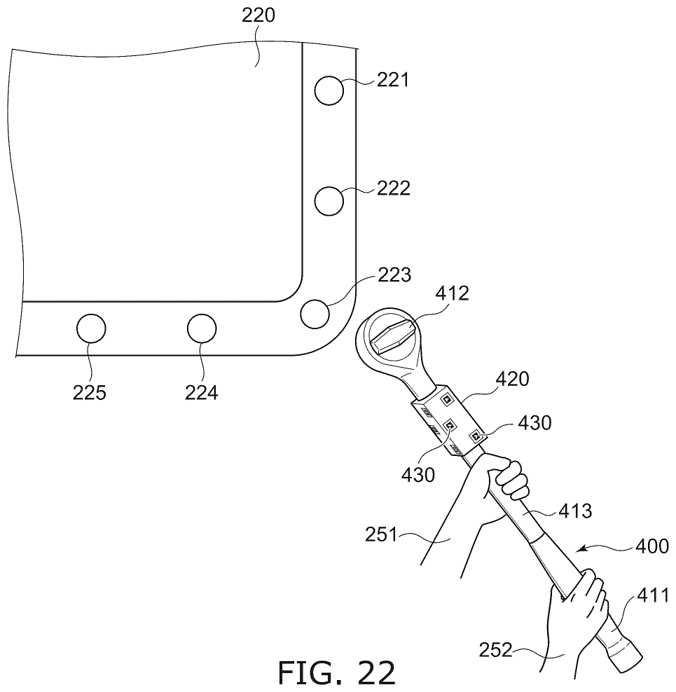

FIGS. 22 to 24 are schematic views for explaining a first modification of the embodiment.

In the example shown in FIG. 22, the fastening locations 221 to 225 of the article 220 are in a high position. Therefore, the worker uses a long wrench 400 to tighten a screw into the fastening locations 221 to 225. During the fastening task, the worker cannot reach the head 412 of the wrench 400. For this reason, instead of the head 412, the worker grips the bar 413 between the head 412 and the grip 411, and tightens the screw.

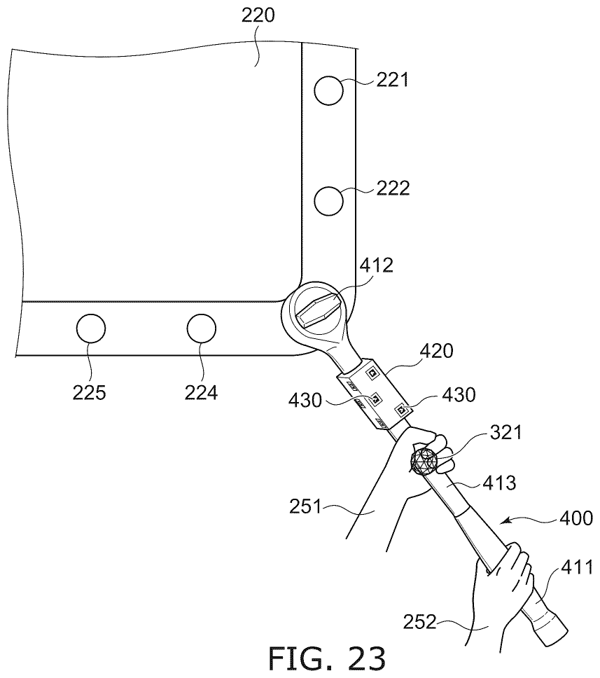

In such a case, as shown in FIG. 23, the processing device 2 displays a virtual object 321 (an example of the first object) at a position where the hand holding the bar 413 passes during the task. When the hand comes into contact with the object 321, the processing device 2 executes the processing from the step S3 shown in FIG. 12. In such a case, only at some time of the task, the hand comes into contact with the object 321. Therefore, the first period is set to be longer. For example, the first period is set to 10 seconds. The fastening of a typical screw can be completed within 5 seconds. When the first period is set to 10 seconds, the steps S3 and subsequent steps are almost certainly executed with the screw-tightening.

When a digital tool is used, the timing of receiving the detection value from the digital tool may be set as the starting point for counting the first period. Each time the processing device 2 receives the detection value from the digital tool, it updates the starting point of the counting of the first period. When the first period elapses without receiving the detection value from the digital tool, the processing device 2 interrupts the processing after the step S3. In that case, the first period is also set, for example, to 10 seconds.

Alternatively, the process after the step S3 may be continued until the hand comes into contact with another object. The processing after the step S3 may be continued until a fastening completion signal is generated. For example, when a digital tool is used, the processing device 2 emits the fastening completion signal when it receives a detection value from the digital tool that exceeds the torque value required for fastening. Alternatively, when the processing device 2 receives a detection value indicating that the torque value required for fastening has been exceeded from the digital tool, it emits the fastening completion signal.

When the hand comes into contact with the object 321, the processing device 2 executes the processing from the step S3 onwards for the first period after the contact. When the hand comes into contact with the object 321 again before the first period has elapsed, the count of the first period is reset. That is, the processing device 2 executes the processing after the step S3 until the first period has elapsed since the hand last contacted the object 321.

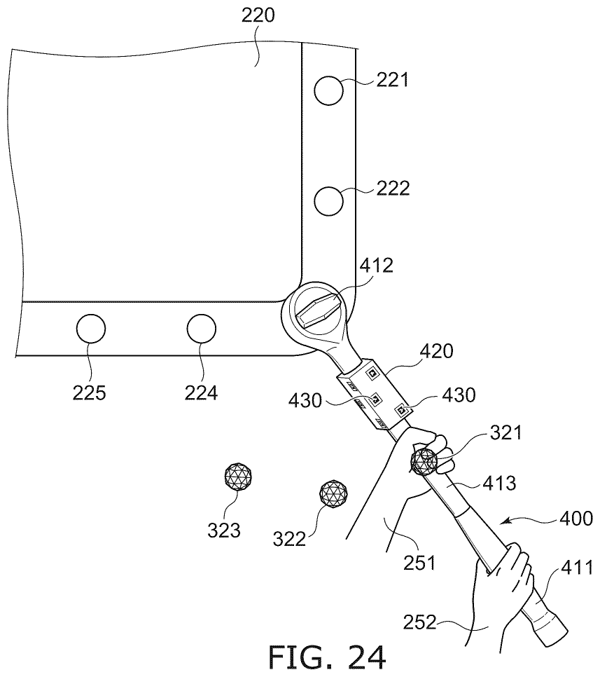

As shown in FIG. 24, multiple objects 321 to 323 may be displayed along the direction in which the hand moves. When the hand comes into contact with any of the objects 321 to 323, the processing device 2 starts counting the first period.

When the position of the head 412 is registered as the position of the wrench 400 corresponding to the marker 430, in the example shown in FIGS. 22 to 24, the first distance d1 becomes longer compared to the example shown in FIGS. 5 to 7. Therefore, the first threshold value compared with the first distance d1 is also set greater than the example shown in FIGS. 5 to 7. The first threshold can be set relative to the distance between the displayed object and the fastening location.

According to the first modification, even when the tool is used in an unconventional manner, the location where the screw is tightened can be presumed, and it can be determined more accurately whether the screw is actually tightened into the presumed location.

### Second Modification

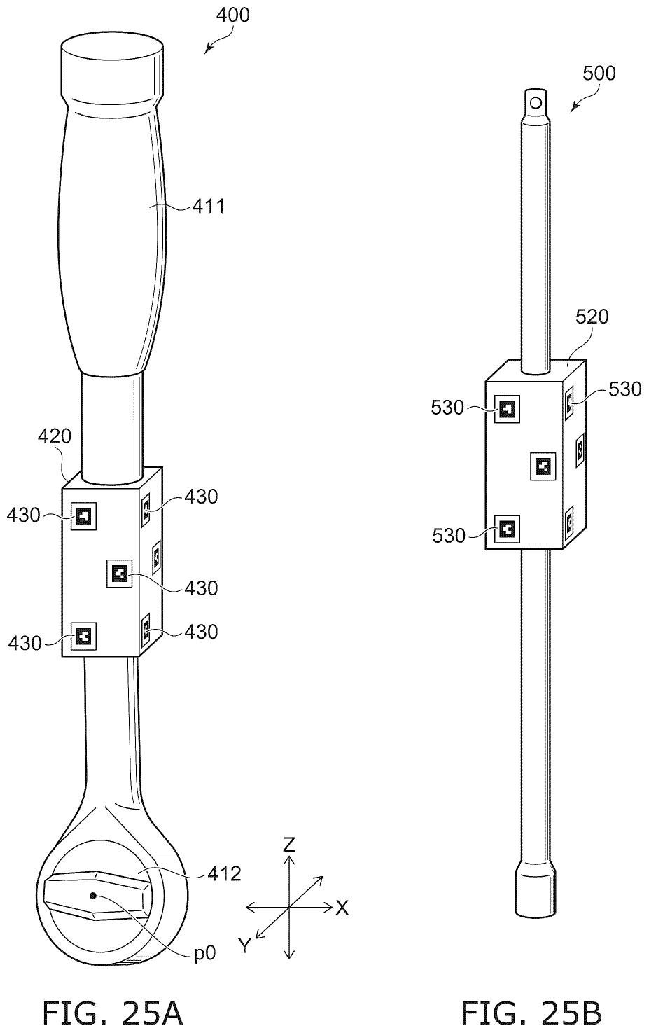

FIG. 25A is a schematic view illustrating an example of a first tool. FIG. 25B is a schematic view illustrating an example of a second tool.

Embodiments of the present invention are also applicable to tasks that require the use of multiple tools. For example, as shown in FIGS. 25A and 25B, a wrench 400 (an example of the first tool) and an extension bar 500 (an example of a second tool) are used to tighten screws.

As described above, multiple markers 430 are attached to the wrench 400. Similarly, multiple markers 530 are attached to the extension bar 500. In the illustrated example, a jig 520 is attached to the extension bar 500. The jig 520 has a similar shape to the jig 420 of the wrench 400. Multiple markers 530 are attached to each plane of the jig 520.

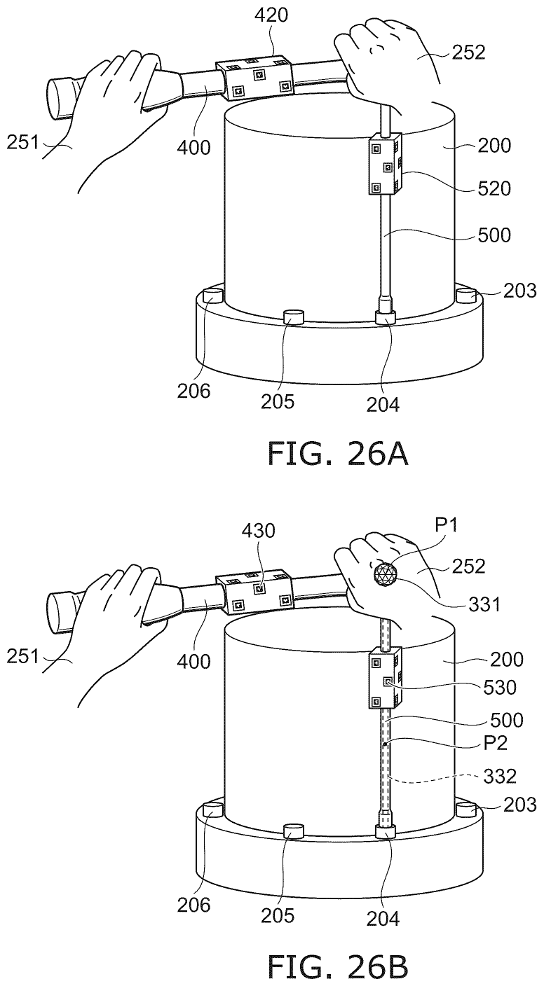

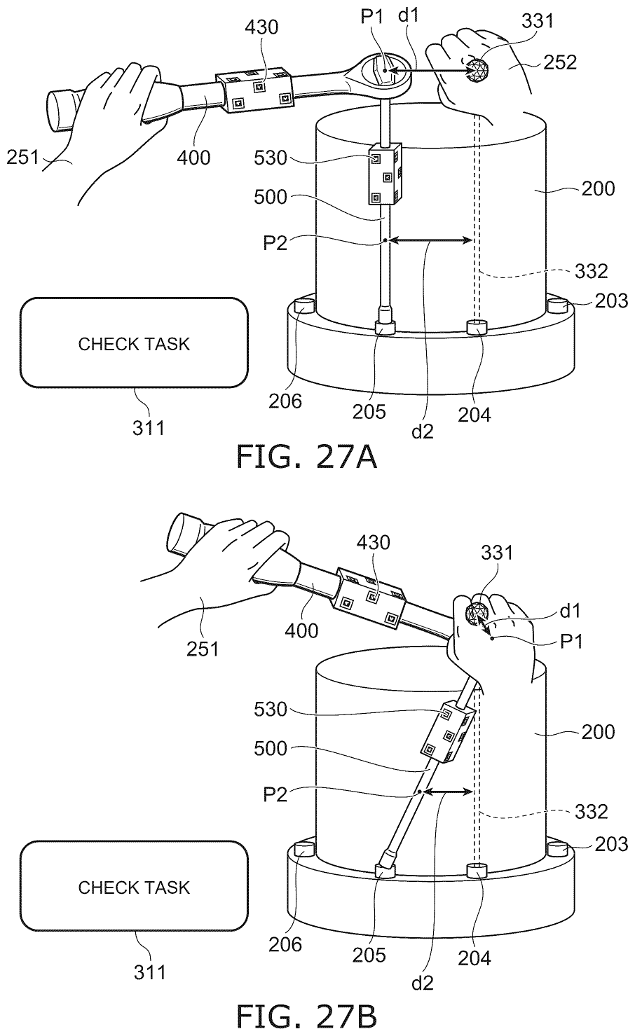

FIG. 26A, FIG. 26B, FIG. 27A, and FIG. 27B are schematic views for explaining a second modification of the embodiment.

When the task is performed using the wrench 400 and the extension bar 500, for example, the worker fits one end of the extension bar 500 onto the screw, as shown in FIG. 26A. The worker then fits the head of the wrench 400 onto the other end of the extension bar 500. The worker holds the head of the wrench 400 with the right hand 252 and grasps the grip of the wrench 400 with the left hand 251. In this state, by rotating the wrench 400, a screw is tightened into the fastening location 204 via the extension bar 500.

For example, the worker wears the MR device 100 shown in FIG. 2 and performs the task. As shown in FIG. 26B, the processing device 150 displays a virtual object 331 (an example of a first object) at a position where the worker's hand should be located. When the extension bar 500 is used, the hand positions away from the fastening location 204. Therefore, the object 331 is also displayed at a distance from the fastening location 204.

The processing device 150 further displays an virtual object 332 (an example of a second object). The object 332 is located between the fastening location 204 and the object 331, and extends along the direction connecting the fastening location 204 and the object 331. The shape and size of the object 332 correspond to the shape and size of the extension bar 500. The object 332 indicates the position and orientation of the extension bar 500 during the task.

When the worker's hand comes into contact with the object 331, the processing device 150 calculates the first position P1 of the wrench 400 based on the positions of the multiple markers 430. Additionally, the processing device 150 calculates the second position P2 of the extension bar 500 based on the positions of the multiple markers 530.

The processing device 150 calculates the first distance between the first position P1 and the object 331 with which the hand came into contact. The processing device 150 compares the first distance with a preset first threshold. Additionally, the processing device 150 calculates the second distance between the second position P2 and the object 332. The processing device 150 compares the second distance with a preset second threshold. The second threshold may be the same as the first threshold or may be different from the first threshold. The second threshold is set in advance by the administrator of the processing system 10. Alternatively, the second threshold value may be automatically calculated from the distance between the fastening locations, the size of the extension bar, etc.

When the first distance is greater than the first threshold or when the second distance is greater than the second threshold, the processing device 150 determines that the screw is not tightened into the presumed location. When the first distance is not greater than the first threshold value and the second distance is not greater than the second threshold, the processing device 150 determines that a screw is tightened into the presumed location.

As an example, the hand not holding a tool is in contact with the object 331 while a screw is tightened into a location different from the presumed location, as shown in FIG. 27A. In such a case, the first distance d1 is greater than the first threshold and the second distance d2 is greater than the second threshold. Therefore, the processing device 150 determines that the screw is not tightened into the presumed location.

As another example, as shown in FIG. 27B, while the hand holding the tool is in contact with object 331, a screw is tightened into a location different from the presumed location. In this example, the extension bar 500 is used at an incorrect angle. In such a case, the first distance d1 is smaller than the first threshold, but the second distance d2 is greater than the second threshold. Therefore, the processing device 150 determines that the screw is not tightened into the presumed location. As shown in FIGS. 27A and 27B, the processing device 150 may display the message 311 encouraging confirmation of the task.

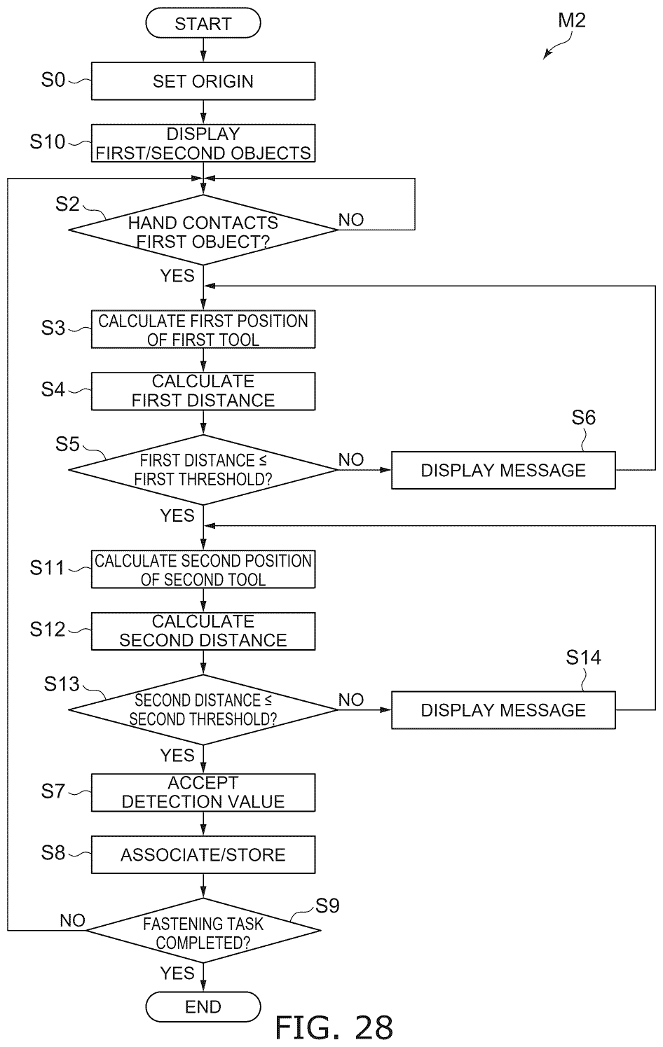

FIG. 28 is a flowchart illustrating a processing method according to the second modification of the embodiment.

The processing method M2 according to the second modification shown in FIG. 28 further includes steps S11 to S14 compared to the processing method M1 shown in FIG. 12. In addition, the processing method M2 includes step S10 instead of the step S1.

In the step S10, following the step S0, the processing device 2 displays the first object and the second object. The first object indicates the position where the hand holding the first tool should be located. The second object indicates the appropriate position and orientation of the second tool. Thereafter, the step S2 is executed, and when it is determined in step S5 that the first distance is less than or equal to the first threshold, the processing device 2 calculates the second position of the second tool (step S11). The processing device 2 calculates the second distance between the second position and the second object (step S12). The processing device 2 determines whether the second distance is less than or equal to the second threshold value (step S13). When the second distance is greater than the second threshold, the processing device 2 displays a message encouraging the worker to confirm (step S14). Thereafter, the second position is calculated again (step S11).

When the second distance is less than or equal to the second threshold, the processing device 2 accepts the detection value transmitted from the digital tool (step S7). The processing device 2 associates the detection value with the data related to the fastening location and stores them in the storage device 5 (step S8). The processing device 2 determines whether the task is completed (step S9). When it is determined that the task is completed, the processing system 10 terminates the processing method M2 shown in FIG. 28.

In the processing method M2, the specific processing order is not limited to the example shown in FIG. 28 and can be appropriately modified. For example, after the first and second positions are calculated, the first distance and the second distance may be calculated. Alternatively, the second position may be calculated, and the first position may be calculated after the second distance and the second threshold value are compared.

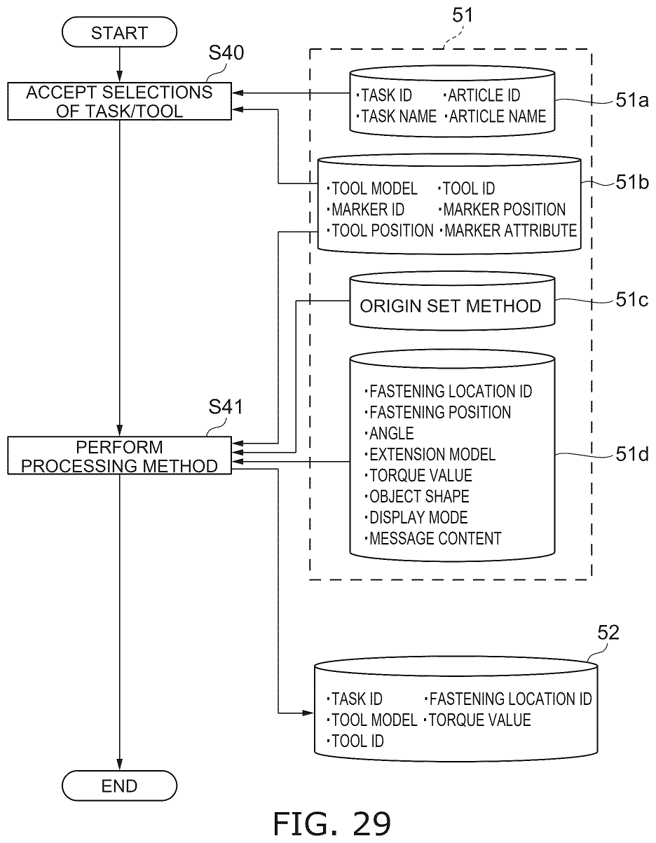

FIG. 29 is a flowchart illustrating the flow of data in the processing method according to the embodiment.

The storage device 5 stores master data 51 and history data 52. The master data 51 includes task master data 51a, tool master data 51b, origin master data 51c, and fastening location master data 51d. The master data 51 is prepared in advance before screw tightening.

As shown in FIG. 29, the processing device 2 accepts the selection of task and the selection of tool (step S40). The task and tool are selected by the worker. The task to be performed and the tool to be used may be instructed by the higher-level system, and the processing device 2 may accept these selections according to the instructions. Based on the data obtained from the imaging device 1 or another sensor, the processing device 2 may determine the task to be performed and the tool to be used. The processing device 2 then selects the task and tool based on the determination result.

The task master data 51a stores a task ID, a task name, an article ID, and an article name. The processing device 2 can accept any of the task ID, the task name, the article ID, or the article name as the selection of the task. The tool master data 51b stores a tool model, a tool ID, a marker ID, a marker position, a tool position, and marker attributes. The tool model indicates the classification of tools by structure, appearance, performance, etc. The processing device 2 can accept either the tool model or the tool ID as the tool selection.

When the task and tool are selected, the processing device 2 executes one of the processing methods described above (step S41). In the processing method, when the origin is set, the origin master data 51c is referred. The origin master data 51c stores a method for setting the origin for each task. The processing device 2 acquires the method for setting the origin in the selected task and sets the origin based on input by the worker.

Additionally, the processing device 2 refers to the fastening location master data 51d. In the fastening location master data 51d, a fastening location ID is stored, and a fastening position, angle, extension model, torque value, object shape, display mode, and message content are stored for each fastening location ID. The fastening position indicates the position of each fastening location. The angle indicates the angle of the tool or extension bar when a screw tightened at each fastening location. The extension model indicates the classification of the extension bar by structure, external shape, performance, etc. The torque value indicates the magnitude of the torque required when a screw is tightened into each fastening location. The object shape indicates the shape of the object displayed corresponding to each fastening location. The display mode indicates the color or pattern of each object to be displayed. The content of the message is the content displayed when it is determined that the screw is not tightened into the presumed location.

The processing device 2 displays each object based on the set origin and the referenced data. The position at which the object is displayed is calculated based on the origin, fastening position, angle, extension model, tool model, etc. For example, the extension model specifies the length of the extension bar. With reference to the fastening position, at the set angle, the second object with the specified length is displayed. Further, the first object is displayed at the set angle and at the position separated from the fastening position by the length of the extension bar.

When it is determined that a screw is tightened into the presumed location and a detection value is received from the tool, the processing device 2 associates the detection value with the data related to the fastening location, and records the data in the history data 52. In the illustrated example, a torque value is recorded as a detection value. The fastening location ID is recorded as data related to the fastening location. In addition, the task ID, the tool ID, and the tool model are associated and recorded in these data.

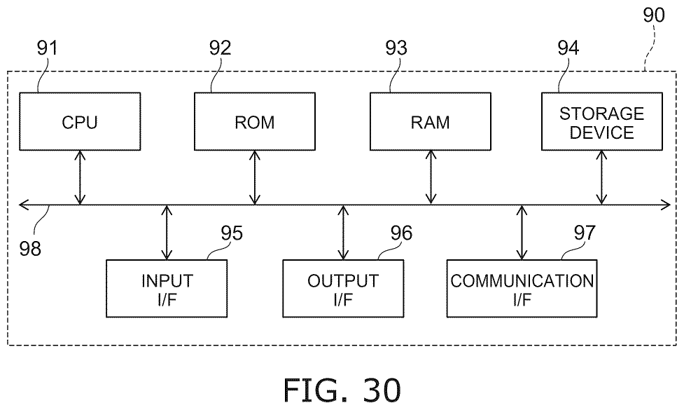

FIG. 30 is a schematic view illustrating a hardware configuration.

For example, a computer 90 shown in FIG. 30 is used as the processing device 2 or the processing device 150. The computer 90 includes a CPU 91, ROM 92, RAM 93, a storage device 94, an input interface 95, an output interface 96, and a communication interface 97.

The ROM 92 stores programs that control the operations of the computer 90. Programs that are necessary for causing the computer 90 to realize the processing described above are stored in the ROM 92. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs. The storage device 94 includes a solid state drive (SSD), etc. The storage device 94 may be used as the storage device 5 or the storage device 170.

The input interface (I/F) 95 can connect the computer 90 to the input device 3. The CPU 91 can read various data from the input device 3 via the input I/F 95.

The output interface (I/F) 96 can connect the computer 90 and an output device. The CPU 91 can transmit data to the display device 4 via the output I/F 96 and can cause the display device 4 to display information.

The communication interface (I/F) 97 can connect the computer 90 and a device outside the computer 90. For example, the communication I/F 97 connects the digital tool and the computer 90 by Bluetooth (registered trademark) communication.

The data processing of the processing device 2 or the processing device 150 may be performed by only one computer 90. A portion of the data processing may be performed by a server or the like via the communication I/F 97.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD-R, DVD-RW, etc.), semiconductor memory, or another non-transitory computer-readable storage medium.

For example, the information that is recorded in the recording medium can be read by the computer (or an embedded system). The recording format (the storage format) of the recording medium is arbitrary. For example, the computer reads the program from the recording medium and causes a CPU to execute the instructions recited in the program based on the read program. In the computer, the acquisition (or the reading) of the program may be performed via a network.

In the description of the embodiment described above, an example in which the processing system 10 is realized as an MR device has been mainly described. However, embodiments of the present invention are not limited to this example. The processing system 10 may be realized by a general-purpose personal computer. In such a case, a keyboard, a microphone, a touchpad, etc. may be used as the input device 3. A monitor is used as the display device 4.

In the example described above, an example in which a screw is tightened into a fastening location has been mainly described. However, embodiments of the present invention are applicable not only when a screw is tightened at the fastening location, but also when the screw at the fastening location is loosened. For example, when maintaining, inspecting, or repairing a product, the screws at the fastening locations may need to be loosened. According to an embodiment of the present invention, it is possible to more accurately determine whether or not a screw is actually being turned at the fastening location corresponding to the object in contact with the hand. As a result, it is possible to generate a task record more accurately.

Embodiments of the present invention include the following features.

### Feature 1

A processing device, configured to:
acquire an image including a hand of a worker and a plurality of markers attached to a first tool for turning a screw;
calculate a first position of the first tool based on a plurality of positions of the plurality of markers in a case where the hand touches a virtual first object; and
determine whether a screw is turned at a fastening location corresponding to the first object based on a first distance between the first object and the first position.

### Feature 2

The processing device according to feature 1, wherein
the processing device is configured to
receive a detection value from the first tool, and
store the detection value in association with data related to the fastening location in a case where the screw is determined to be turned at the fastening location.

### Feature 3

The processing device according to feature 1 or 2, wherein
the processing device is configured to
   in a case where the screw is turned by the first tool via a second tool, calculate a second position of the second tool based on a plurality of positions of a plurality of markers attached to the second tool.
   calculate a second distance between a virtual second object and the second position, the second object being displayed between the fastening location and the first object. and
   determine based on the first distance and the second distance whether the screw is turned at the fastening location.

### Feature 4

The processing device according to any one of features 1 to 3, wherein the processing device is configured to display a message in a case where the screw is determined not to turned at the fastening location.

### Feature 5

The processing device according to any one of features 1 to 4, wherein
the processing device is configured to
   in a case where the image including four or more markers, extract a first marker, a second marker, and a third marker from the four or more markers, and
measure a position of each of the first to third markers to calculate the first position.

### Feature 6

The processing device according to feature 5, wherein
the processing device is configured to
   calculate a rotation amount and a translation amount from pre-registered positions of the first to third markers to the measured positions of the first to third markers, and
   calculate the first position by rotating and translating a pre-registered position of the first tool corresponding to the first to third markers according to the rotation amount and the translation amount.

### Feature 7

The processing device according to feature 5, wherein
the processing device is configured to
   calculate an affine transformation matrix indicating rotation, deformation, and translation from pre-registered positions of the first to third markers to the measured positions of the first to third markers, and
   calculate the first position by affine-transforming a pre-registered position of the first tool using the affine transformation matrix.

### Feature 8

The processing device according to any one of features 5 to 7, wherein
the processing device is configured to
   extract combinations of three markers from the plurality of markers,
   generate a triangle for each combination,
   extract one or more triangles with a side along a first direction from a plurality of the triangles, the first direction corresponding to an orientation of the first tool,
   extract one triangle with the smallest angle between a normal vector of the triangle and a vector connecting an observation point and the triangle, and
   extract three markers corresponding to the one triangle from the plurality of markers as the first marker, the second marker, and the third marker.

### Feature 9

The processing device according to any one of features 1 to 4, wherein
the processing device is configured to
   set three points with fixed relative positions based on the plurality of markers, and
   calculate the first position using a position of each of the three points.

### Feature 10

A processing system, comprising:
the processing device according to any one of features 1 to 9;
a display device configured to display the first object; and
an imaging device configured to image the hand and the plurality of markers.

### Feature 11

A mixed reality device, configured to:
display a virtual first object indicating a position where a hand of a worker should be positioned;
image the hand and a plurality of markers attached to a first tool for turning a screw;
calculate a first distance between a first position of the first tool and the first object in a case where the hand comes into contact with the first object, the first position being calculated based on positions of the plurality of markers;
display a message in a case where the first distance is longer than a first threshold.

### Feature 12

A processing method, comprising:
causing a display device to display a virtual first object indicating a position where a hand of a worker should be positioned;
causing a processing device to calculate a first position of a first tool for turning a screw using a plurality of markers attached to the first tool; and
causing the processing device to determine whether the screw is turned at a fastening location corresponding to the first object based on a first distance between the first position and the first object.

### Feature 13

The processing method according to feature 12, wherein:
a jig having a plane is attached to the first tool,
the plurality of markers including a first marker, a second marker, and a third marker are provided on the plane, and
a distance between the first marker and the second marker is different from a distance between the second marker and the third marker.

### Feature 14

A program causing a computer to execute the processing method according to feature 12 or 13.

### Feature 15

A non-transitory computer-readable storage medium storing the program according to feature 14.

According to the embodiment described above, a processing device, a processing system, a mixed reality device, a processing method, a program, and a storage medium are provided that can determine more accurately whether or not a screw is actually tightened into the fastening location corresponding to the virtual object in contact with the hand. According to embodiments, tasks involving screws can be more appropriately supported.

In the specification, “or” shows that “at least one” of items listed in the sentence can be adopted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A processing device, configured to:
acquire an image including a hand of a worker and a plurality of markers attached to a first tool for turning a screw;
calculate a first position of the first tool based on a plurality of positions of the plurality of markers in a case where the hand touches a virtual first object; and
determine whether a screw is turned at a fastening location corresponding to the first object based on a first distance between the first object and the first position.

2. The processing device according to claim 1, wherein
the processing device is configured to
receive a detection value from the first tool, and
store the detection value in association with data related to the fastening location in a case where the screw is determined to be turned at the fastening location.

3. The processing device according to claim 1, wherein
the processing device is configured to
in a case where the screw is turned by the first tool via a second tool, calculate a second position of the second tool based on a plurality of positions of a plurality of markers attached to the second tool,
calculate a second distance between a virtual second object and the second position, the second object being displayed between the fastening location and the first object, and
determine based on the first distance and the second distance whether the screw is turned at the fastening location.

4. The processing device according to claim 1, wherein
the processing device is configured to display a message in a case where the screw is determined not to turned at the fastening location.

5. The processing device according to claim 1, wherein
the processing device is configured to
in a case where the image including four or more markers, extract a first marker, a second marker, and a third marker from the four or more markers, and
measure a position of each of the first to third markers to calculate the first position.

6. The processing device according to claim 5, wherein
the processing device is configured to
calculate a rotation amount and a translation amount from pre-registered positions of the first to third markers to the measured positions of the first to third markers, and
calculate the first position by rotating and translating a pre-registered position of the first tool corresponding to the first to third markers according to the rotation amount and the translation amount.

7. The processing device according to claim 5, wherein
the processing device is configured to
calculate an affine transformation matrix indicating rotation, deformation, and translation from pre-registered positions of the first to third markers to the measured positions of the first to third markers, and
calculate the first position by affine-transforming a pre-registered position of the first tool using the affine transformation matrix.

8. The processing device according to claim 5, wherein
the processing device is configured to
extract combinations of three markers from the plurality of markers,
generate a triangle for each combination,
extract one or more triangles with a side along a first direction from a plurality of the triangles, the first direction corresponding to an orientation of the first tool,
extract one triangle with the smallest angle between a normal vector of the triangle and a vector connecting an observation point and the triangle, and
extract three markers corresponding to the one triangle from the plurality of markers as the first marker, the second marker, and the third marker.

9. The processing device according to claim 1, wherein
the processing device is configured to
set three points with fixed relative positions based on the plurality of markers, and
calculate the first position using a position of each of the three points.

10. A processing system, comprising:
the processing device according to claim 1;
a display device configured to display the first object; and
an imaging device configured to image the hand and the plurality of markers.

11. A mixed reality device, configured to:
display a virtual first object indicating a position where a hand of a worker should be positioned;
image the hand and a plurality of markers attached to a first tool for turning a screw;
calculate a first distance between a first position of the first tool and the first object in a case where the hand comes into contact with the first object, the first position being calculated based on positions of the plurality of markers;
display a message in a case where the first distance is longer than a first threshold.

12. A processing method, comprising:
causing a display device to display a virtual first object indicating a position where a hand of a worker should be positioned;
causing a processing device to calculate a first position of a first tool for turning a screw using a plurality of markers attached to the first tool; and
causing the processing device to determine whether the screw is turned at a fastening location corresponding to the first object based on a first distance between the first position and the first object.

13. The processing method according to claim 12, wherein:
a jig having a plane is attached to the first tool,
the plurality of markers including a first marker, a second marker, and a third marker are provided on the plane, and
a distance between the first marker and the second marker is different from a distance between the second marker and the third marker.

14. A non-transitory computer-readable storage medium storing a program, the program causing a computer to execute the processing method according to claim 12.
